(19) United States
(12) Patent Application Publication
(10) Pub. No.: US 2023/0219861 A1
(43) Pub. Date: Jul. 13, 2023

(54) METHOD FOR PRODUCING A FERTILISER AND FERTILISER COMPOSITION

(71) Applicant: CCm Technologies Limited, Swindon (GB)

(72) Inventor: Peter Hammond, Swindon (GB)

(21) Appl. No.: 18/004,409

(22) PCT Filed: Jul. 7, 2021
(86) PCT No.: PCT/GB2021/051737

§ 371 Date: Jan. 5, 2023

(30) Foreign Application Priority Data
Jul. 7, 2020 (GB) 2010449.3

(51) Int. Cl. C05C 3/00; C05G 5/12

(52) U.S. Cl. CPC C05C 3/00; C05G 5/12

(57) ABSTRACT

A method of producing a fertilizer composition, the method comprising:
(a) providing a composition comprising ammonia; and
(b) contacting the composition provided in step (a) with: (i) a composition comprising carbon dioxide; and (ii) a source of sulfate ion; and (iii)cellulosic fibres.

The present invention relates to a method of preparing a fertiliser, to a fertiliser composition prepared by the method and to methods and uses relating thereto. In particular the present invention seeks to provide a fertiliser composition that is prepared from one or more waste products.

As the world’s population grows there is an ever increasing need to maximise resources, reduce waste and recycle as much as possible. In particular it is essential to reduce waste that is sent to landfill and to reduce emissions of carbon dioxide. Furthermore there is a need to maximise crop yield and thus the provision of safe and effective fertilisers is also a necessity.

According to a first aspect of the present invention there is provided a method of producing a fertiliser composition, the method comprising:
(a) providing a composition comprising ammonia;
(b) contacting the composition provided in step (a) with: (i) a composition comprising carbon dioxide; (ii) a source of sulfate ion; and (iii) cellulosic fibres.

Step (a) of the method of the present invention involves providing a composition comprising ammonia.

The composition provided in step (a) comprises ammonia. This may be provided directly as ammonia or a source of ammonia may be used, such as a compound which releases ammonia or is converted to ammonia.

In some embodiments the ammonia may be provided as a gas. The ammonia may be provided as anhydrous ammonia.

In preferred embodiments ammonia is not provided as a gas.

In some embodiments a solution of ammonia may be used. In some embodiments a solid ammonium salt may be used, for example solid ammonium hydroxide may be used.

In some embodiments the composition comprising ammonia comprises a waste stream from an industrial process.

In some preferred embodiments the composition provided in step (a) is an aqueous composition.

In some embodiments the composition comprising ammonia provided in step (a) comprises an anaerobic digestate.

As the skilled person will appreciate an anaerobic digestate is the material left following anaerobic digestion of a biodegradable feedstock. In some preferred embodiments the digestate is a methanogenic digestate.

Suitably the anaerobic digestate is provided as an aqueous composition, typically in the form of a sludge or slurry.

The anaerobic digestate may be obtained from the anaerobic digestion of any suitable material, for example grass silage, chicken litter, cattle slurry, wholecrop rye, energy beet, potato, wheat straw, chicken manure, cattle manure with straw, pig manure, food waste, food processing waste and sewage sludge.

Typically the anaerobic digestate is obtained from the anaerobic digestion of food waste or from the anaerobic digestion of farm slurry, for example pig or cow manure or chicken waste.

In some preferred embodiments the composition provided in step (a) includes ammonia and an anaerobic digestate.

Anaerobic digestates typically comprise ammonia. However in preferred embodiments the composition provided in step (a) comprises a further source of ammonia in addition to any ammonia originally present in the anaerobic digestate.

In some embodiments gaseous ammonia may be pumped through an anaerobic digestate composition to produce the composition provided in step (a).

In some embodiments an aqueous ammonia solution may be admixed with the anaerobic digestate.

In some embodiments solid ammonium hydroxide may be admixed with the anaerobic digestate.

In some embodiments ammonia gas (preferably anhydrous ammonia gas) is pumped through the anaerobic digestate.

In preferred embodiments the composition provided in step (a) comprises an anaerobic digestate and from 10 to 60, preferably 20 to 50, more preferably 30 to 40 wt% ammonia.

In the method of the present invention ammonia may be added to an anerobic digestate. Ammonia is suitably not removed or released from an anaerobic digestate.

Step (b) of the method of the present invention involves contacting the mixture provided in step (a) with (i) a composition comprising carbon dioxide; (ii) a source of sulfate ions; and (iii) a composition comprising cellulosic fibres. Steps (b)(i), (b)(ii), and (b)(iii), may be carried out in any order.

One or more of these steps may be combined.

In some embodiments the composition comprising ammonia provided in step (a) may be first contacted with carbon dioxide according to step (b)(i). A source of sulfate may then be added to the resultant mixture according to step (b)(ii), before adding cellulosic fibres according to step (b)(iii).

In some embodiments a source of sulfate ions may be added according to step (b)(ii) to the composition comprising ammonia provided in step (a). This composition may then be admixed with cellulosic fibres according to step (b)(iii) and the resultant mixture contacted with a composition comprising carbon dioxide according to step (b)(i).

In some embodiments the composition comprising ammonia provided in step (a) may be admixed with cellulosic fibres according to step (b)(iii). This mixture is then contacted with a composition comprising carbon dioxide according to step (b)(i). A source of sulfate ions may be added to the mixture according to step (b)(ii) before or after contact with the composition comprising carbon dioxide.

In some embodiments a source of sulfate ions may be added to the composition provided in step (a) according to step (b)(ii). A composition comprising carbon dioxide may then be contacted with the resultant composition according to step (b)(i). This product is then admixed with cellulosic fibres according to step (b)(iii).

In some embodiments the composition provided in step (a) is first contacted with carbon dioxide according to step (b)(i), then admixed with cellulosic fibres according to step (b)(iii) and then contacted with a source of sulfate ions according to step (b)(ii).

Step (b)(i) involves contacting the composition provided in step (a) with a composition comprising carbon dioxide.

The composition comprising carbon dioxide may consist essentially of carbon dioxide and/or it may comprise a mixture of carbon dioxide and one or more further components.

In some embodiments the carbon dioxide may be provided in solid form.

Preferably step (b)(i) involves contacting the composition provided in step (a) with a composition comprising carbon dioxide wherein the composition is in gaseous form. The composition may comprise neat carbon dioxide gas and/or it may comprise a gaseous mixture of carbon dioxide and one or more further gases.

Preferably component (iv) comprises at least 5 vol% carbon dioxide, preferably at least 10 vol%, preferably at least 20 vol%.

Component may (iv) comprises at least 50 vol% carbon dioxide, suitably at least 60 vol%, for example at least 80 vol%, at least 90 vol% or at least 95 vol%.

In some embodiments step (b)(i) involves contacting the composition provided in step (a) with neat carbon dioxide gas.

In some embodiments step (b)(i) involves contacting the mixture obtained in step (a) with the exhaust gas from combustion, for example the combustion of fossil fuel. For example step (b)(i) may involve contacting the flue gases from a power station with the composition provided in step (a).

The use of flue gases to provide the carbon dioxide is highly beneficial because the SOₓ and NOₓ gases present in the flue gas mixture may also dissolve in the composition and provide additional nutrients in the final fertiliser composition in the form of sulphates and nitrates.

In some especially preferred embodiments the source of carbon dioxide is biogas and step (b) involves contacting the composition provided in step (a) with biogas.

Biogas describes the mixture of methane and carbon dioxide that is obtained during anaerobic digestion. It may also comprise other gases in minor amounts, for example hydrogen sulphide. The exact levels of carbon dioxide and methane present in biogas depends on the mixture that has been digested and the digestion conditions. Typically biogas comprises from 20 to 80 vol% carbon dioxide, for example 30 to 70 vol%. In some embodiments biogas comprises from 40 to 45 vol% carbon dioxide and 55 to 60 vol% methane.

In some embodiments the composition comprising carbon dioxide may comprise the exhaust gases from the combustion of biogas, or of methane recovered from biogas.

One particular advantage of the method of the present invention is that it can use both the digestate and the biogas produced during anaerobic digestion.

In some preferred embodiments in which the composition comprising carbon dioxide comprises the exhaust gas from the combustion of fossil fuel and/or biogas, the hot gas mixture may be first contacted with a heat exchanger to capture heat energy from said gases.

During step (b)(i) the carbon dioxide which is contacted with the composition provided in step (a) is suitably retained within and forms part of a new composition. Thus step (b)(i) suitably removes carbon dioxide from the source of carbon dioxide that it is contacted with. Thus in some embodiments step (b)(i) may involve capturing carbon dioxide from an exhaust gas produced by combustion, for example of fossil fuel.

In some preferred embodiments step (b)(i) involves removing carbon dioxide from biogas. The resulting biogas thus has an increased relative concentration of methane and will therefore burn more easily. Thus the present invention may provide a method of enriching biogas.

In step (b)(i) carbon dioxide is suitably contacted with the composition provided in step (a) for a time sufficient to ensure that at least 50% of the ammonia molecules present in the composition form an interaction with the carbon dioxide, preferably to ensure that at least 70%, more preferably at least 90%, preferably at least 95% and most preferably substantially all of the all of the ammonia molecules form an interaction with the carbon dioxide. Without being bound by theory it is believed that ammonium carbamates and bicarbonates are initially formed. This is then converted to ammonium carbonate. An ion exchange reaction then typically follows to yield ammonium sulfate and calcium carbonate.

The reaction of carbon dioxide with ammonia that occurs in step (b)(i) is an exothermic reaction. Heat from this reaction may be captured. It may suitably be reused in the process.

In step (b)(i) heat from the source of carbon dioxide and exothermic heat of reaction may be captured.

Although hot gases and an exothermic reaction are involved in step (b)(i), preferably no external source of heat is supplied to the system.

In preferred embodiments the method of the present invention does not include any heating steps.

Suitably the composition of the mixture in step (b)(i) remains at a temperature of less than 100° C., preferably less than 80° C., suitably less than 60° C., preferably less than 50° C., suitably less than 40° C. throughout the contact with the composition comprising carbon dioxide.

Step (b)(ii) involves contacting the composition provided in step (a) with a source of sulfate ions.

Suitably the source of sulfate ion is a metal or ammonium salt. Preferably the source of sulfate ion is a metal salt, preferably an alkali metal or alkaline earth metal salt.

In some embodiments the sulfate ion is provided a water soluble form.

In some preferred embodiments the sulfate is provided as a calcium salt.

The source of sulfate may be provided as a solid or a liquid. It may suitably be provided as a slurry.

In some embodiments the source of sulfate ion is provided as an aqueous solution or suspension. In some preferred embodiments the sulfate is added in solid form, suitably as a powder.

In some preferred embodiments the source of sulfate is admixed with an anaerobic digestate. This is suitably in addition to any digestate provided in step (a). In such embodiments an aqueous solution or suspension of a sulfate salt may be admixed with the anaerobic digestate or a solid sulfate source may be dissolved in the digestate.

The source of sulfate ion may be a natural material or a waste material from an industrial farming process.

For example, in some embodiments the source of sulfate ion comprises gypsum.

Gypsum (calcium sulfate dihydrate, CaSO₄▪2H₂O) is the main product of desulfurization system for the removal of SOₓ at fossil-fuel power plants.

In some embodiments the source of sulfate ion comprises a waste stream from an industrial process. For example the source of sulfate ion may comprise the residue from an industrial scrubbing process, for example used limestone scrubbers from a coal fired power station. In some preferred embodiments the source of sulfate ion is the waste stream from the desulfurization system for the removal of SOₓ at fossil-fuel power plants.

Preferably the source of sulfate is solid powdered gypsum.

Without being bound by theory it is believed that in the present invention the following reaction occurs:

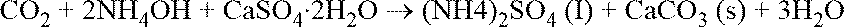

In some embodiments the method of the first aspect of the present invention does not involve a step (b)(iii) of contacting the composition provided in step (a) with a composition comprising cellulosic fibres. In such embodiments the method of the first aspect suitably provides a fertiliser composition in the form of a liquid or paste. An advantage of providing a composition in liquid form is that it is sprayable.

The method of the first aspect includes a step (b)(iii) of contacting the composition provided in step (a) with cellulosic fibres.

Any suitable source of cellulose fibres may be used.

Suitable cellulosic fibres include natural cellulosic fibres and semi-synthetic or processed cellulosic fibres.

The cellulosic fibres may comprise natural fibres and/or synthetic fibres and/or semi-synthetic fibres, for example regenerated cellulose products. Suitable synthetic fibres include polyamides, polyesters and polyacrylics. Preferably the composition used in step (b)(iii) comprises natural fibres.

Suitable natural cellulosic fibres for use herein include cotton, hemp, flax, silk, jute, kenaf, ramie, sisal, kapok, agave, rattan, soy bean, vine, banana, coir, stalk fibres and mixtures thereof.

In some preferred embodiments the cellulosic fibres are provided in a waste product or a by-product from agriculture. Such cellulosic fibres would otherwise have little or no value in other applications. Suitable waste products or by-products may be the stems, leaves, chaff or husks of crops, for example cereals or rapeseed. In some preferred embodiments the cellulosic fibres comprise straw or wood pulp.

In some embodiments the cellulosic fibres may comprise wood pulp, for example the material sold under the trade mark TENSEL.

In some embodiments the cellulosic fibres may comprise the waste directly obtained from pulp mills, for example pine pulp.

In some embodiments the cellulosic fibres may comprise a straw material obtained from cereals, for example wheat, rye or barley.

In preferred embodiments the cellulosic fibres are provided from a waste material.

In some preferred embodiments step (b)(iii) comprises contacting the composition provided in step (a) with partially decomposed organic matter containing cellulosic fibres.

Suitable sources of partially decomposed organic matter include compost or composting matter.

Compost is typically made up of organic material such as leaves, plant waste and food waste which has been decomposed under wet and aerobic conditions.

Thus in some preferred embodiments step (b)(iii) may involve adding a compost material comprising cellulosic fibres to the composition provided in step (a).

In some embodiments step (b)(iii) may involve contacting an anaerobic digestate admixed with cellulosic fibres with the composition provided in step (a).

This may be provided alternatively or additionally to an anaerobic digestate provided in step (a).

For example the present invention may use the anaerobic digestate from animal waste wherein the animal waste is not separated from organic matter admixed therewith prior to digestion. For example sawdust or silage which is mixed with animal waste may be added to an anaerobic digester. The animal manure may be digested under anaerobic conditions but the cellulose or other organic matter present in the sawdust or silage may not be fully digested. However the resultant mixture comprising an anaerobic digestate and partially decomposed organic matter including cellulosic fibres could be useful in step (b)(iii).

Compost and/or an anaerobic digestate may be added in step (b)(iii). However in preferred embodiments once this step is complete further compositing or digestion steps are not carried out.

In some embodiments step (b)(iii) is carried out before steps (b)(i) and (b)(ii). In such embodiments the method of the first aspect involves contacting cellulosic fibres with a composition comprising ammonia. The ammonia loaded fibres are then suitably treated with carbon dioxide and a source of sulfate ions.

In such embodiments the surface of the cellulosic material and ammonia are believed to interact in a way which (though not at present fully understood) appears to promote the take-up of carbon dioxide (b)(i).

Without being bound by theory, it is believed that hydrogen bonding occurs between the amino functionality and the surface of the cellulosic material.

The composition comprising ammonia may be applied to the cellulosic fibres spraying, padding or immersion. In some preferred embodiments the composition comprising ammonia is poured onto the cellulosic fibres and they are then mixed together.

In some embodiments the cellulosic fibres may be added last, after the composition comprising ammonia has been contacted with carbon dioxide and a source of sulfate ions.

The amount of cellulosic fibres used will depend on the nature of the cellulosic fibres and the nature of the composition provided in step (a).

Typically ratio weight of the composition provided in step (a) to cellulosic fibres is from 50:1 to 1:5, preferably from 30:1 to 1:2, more preferably from 20:1 to 1:1, for example from 10:1 to 1:1 or from 5:1 to 1:1.5 or from 3:1 to 2:1.

In such embodiments the method of the present invention involves providing a composition comprising an amino compound, contacting this composition with carbon dioxide and a source of sulfate ion, and then adding cellulosic fibres to the resultant mixture to provide a fertiliser composition.

In some embodiments the method of the present invention may involve the addition of one or more further components. Preferably the one or more further components provides a further source of one or more nutrients.

The one or more further components may be added before, after or during step (a); and/or before, during or after step (b)(i); and/or before, during or after step (b)(ii) and/or before, furing or after step (b)(iii).

In preferred embodiments the one or more further components comprises a waste material.

In some embodiments the method of the present invention further involves adding a source of nitrate ion.

The source of nitrate may be added at any stage.

The source of nitrate may be added before, after or during step (a); and/or before, during or after step (b)(i); and/or before, during or after step (b)(ii) and/or before, during or after step (b)(iii).

Suitably the source of nitrate ion is a water soluble nitrate salt. Suitable nitrate salts include alkali metal, alkaline earth metal and ammonium salts.

A preferred source of nitrate ions is calcium nitrate.

The source of nitrate ion may be provided as a solid or a liquid.

In some embodiments the source of nitrate may comprise a waste material.

For example, in some embodiments the source of nitrate may comprise a waste stream from the ODDA/nitrophosphate process. Such a waste stream will also comprise phosphate residues thus providing a source of phosphorous in the fertiliser composition obtained by the method of the invention.

In some embodiments the source of nitrate may comprise waste from the scrubbing of combustion exhausts with nitric acid.

In some embodiments the source of nitrate ion is nitric acid.

In some embodiments the source of nitrate ion is calcium nitrate provided by the reaction of wood ash and nitric acid.

Preferably the source of nitrate is added after steps (b)(i), (b)(ii) and (b)(iii).

In some embodiments the method of the present invention further involves adding a source of phosphorus.

The source of phosphorus may be added at any stage. Suitable sources of phosphorous include the incinerated bones of animals.

The source of phosphorus may be added before, after or during step (a); and/or before, during or after step (b)(i); and/or before, during or after step (b)(ii); and/or before, during or after step (b)(iii).

Phosphorus may be present in an anaerobic digestate provided in step (a) and/or step (b)(ii).

A waste stream from the ODDA/nitrophosphate process may be used to provide a source of nitrate and a source of phosphorus.

Further or alternative sources of phosphorus may be also added.

The material obtained following steps (a) and (b) of the method of the present invention can be used directly as a fertiliser composition and is highly nutritious. It contains many of the minerals that plants need for growth. It also provides a useful means of storing carbon dioxide.

This product obtained after steps (a) and (b) can be used directly as a fertiliser or can be further processed to provide an easier to handle form.

In some embodiments the method of the present invention involves a further step (c) of further processing the material obtained in steps (b). The further processing step (c) may involve drying, pulverising and/or granulating the material. Such processing methods will be known to the person skilled in the art.

Preferably step (c) involves pelletising the material obtained after steps (a) and (b). It has been advantageously found that this material is easily pelletised, especially in embodiments in which step (b)(iii) is carried out after steps (b)(i) and (b)(ii). The pellets do not clump together and spread as readily as leading commercially available fertiliser compositions of the prior art.

Step (b)(i) of the method of the present invention is exothermic and the method may further involve capturing the heat obtained in step (b)(i). This heat can be reused elsewhere in the process, for example to assist a drying step or it can be used in external processes.

Advantageously the present invention does not require high temperatures and pressure to be used. Suitably a temperature of less than 80° C. and a pressure of less than 20 bar is maintained throughout the process. At a temperature of around 80° C. a pressure of less than 2 bar, for example about 1 bar may be maintained throughout the process.

Thus the method of the first aspect of the present invention may in some embodiments be carried out at ambient pressure.

According to a second aspect of the invention there is provided a fertiliser composition obtained by the method of the first aspect.

Preferred features of the second aspect are as defined in relation to the first aspect.

Further preferred features of the first and second aspects of the present invention will now be described.

The fertiliser composition provided by the present invention suitably comprises at least 3 wt % of nitrogen, suitably at least 5 wt%, preferably at least 10 wt%. Suitably the fertiliser composition provided by the present invention comprises up to 32 wt% nitrogen, preferably up to 30 wt%, for example up to 20 wt%.

In some embodiments the composition comprises from 3 to 5 wt% nitrogen.

In some embodiments the composition comprises from 5 to 10 wt% nitrogen.

In some embodiments the composition comprises from 10 to 15 wt% nitrogen.

Suitably the composition comprises 2 to 10 wt% sulfur.

The composition of the present invention preferably comprises one or more further plant nutrients, for example potassium or phosphate.

In some embodiments the composition comprises 2 to 15 wt% potassium.

In some embodiments the composition comprises 2 to 15 wt% phosphate.

The present invention offers significant advantages in that it uses multiple waste products to generate a useful fertiliser composition. For example the present invention can make use of an anaerobic digestate which is generally considered unsuitable for direct use as a fertiliser, as it is in the form of a sludge and thus difficult to apply. By admixing with cellulosic fibres along with other components, an easier to handle solid fertiliser composition having an improved nutrient composition is provided. Furthermore the invention can make use of the biogas produced during anaerobic digestion. Thus the present invention can be put into effect at a location where anaerobic digestion is taking place.

For example the present invention may use the anaerobic digestate from animal waste wherein the animal waste is not separated from organic matter admixed therewith prior to digestion. For example sawdust or silage which is mixed with animal waste may be added to an anaerobic digester. The animal manure may be digested under anaerobic conditions but the cellulose or other organic matter present in the sawdust or silage may not be fully digested. However the resultant mixture comprising an anaerobic digestate and partially decomposed organic matter could be used in the present invention.

The partially decomposed organic matter is suitably provided in solid form. However it may be wet and it may be already admixed with a digestate composition. The present invention could thus find particular use on a farm where animal waste is processed by anaerobic digestion. Thus the present invention may provide a method of preparing a fertiliser composition comprising selecting a mixture of animal waste and a solid organic material; adding enzymes to effect anaerobic digestion of animal waste and collecting the biogas produced therefrom; admixing the digestate and solid organic material with a source of sulfate and ammonia; and contacting the biogas with the resultant mixture.

A further advantage of some fertiliser compositions of the present invention is that they may be used on soil which has been certified as organic.

The present inventors have tested products of the present invention and have found them to be as effective as a leading major fertiliser composition.

In some preferred embodiments the composition is obtained by admixing partially decomposed organic matter comprising cellulosic fibres with aqueous ammonia, gypsum, carbon dioxide and a liquid anaerobic digestate.

Suitably the fertiliser is provided by admixing these components in the following ratios by weight:
30 to 60, preferably 40 to 50 parts partially decomposed organic matter comprising cellulosic fibres;
5 to 20, preferably 10 to 15 parts liquid anaerobic digestate;
2 to 15, preferably 5 to 10 parts carbon dioxide;
10 to 25, preferably 12 to 20 parts gypsum; and
10 to 30 parts, preferably 15 to 25 parts aqueous ammonia.

An aqueous ammonia used herein typically comprises 5 to 25, suitably 15 to 20 wt% ammonia.

The present invention may further provide the use of a mixture of partially decomposed organic matter comprising cellulosic fibres, an anaerobic digestate, a source of sulfate ion, ammonia and carbon dioxide as a fertiliser, preferably as a fertiliser for organically certified soil.

The invention may suitably provide the use of a mixture of partially decomposed organic matter comprising cellulosic fibres, aqueous ammonia, gypsum, carbon dioxide and a liquid anaerobic digestate as an organic fertiliser.

According to a third aspect of the present invention there is provided a method of increasing the nutrient content of a plant growing medium, the method comprising:
(a) providing a composition comprising an ammonia;
(b) contacting the composition provided in step (a) with: (i) a composition comprising carbon dioxide; (ii) a source of sulfate ions; and (iii) cellulosic fibres;
(c) optionally pelletising the material obtained after steps (b); and
(d) admixing the mixture obtained after steps (b) and/or (c) with the plant growing medium.

Steps (a), (b) and (c) of the method of the third aspect are preferred as defined in relation to the first aspect and preferred features of the first aspect apply to the third aspect.

The invention may be used to increase the nutrient content of any suitably plant growing medium.

Suitable plant growing media will be known to the person skilled in the art and include for example soil, compost, clay, coco, and peat.

Preferably the plant growing medium is soil.

Preferably in step (d) the mixture obtained after steps (b) and/or (c) is admixed with the plant growing medium in an amount of from 1 to 50 wt%, preferably 5 to 20 wt%.

As previously described herein the present invention offers significant advantages. In particular the combination of components used in the invention provides a solid fertiliser composition which is easy to handle and easy to pelletise.

Furthermore the inclusion of cellulosic fibres provides a solid matrix on which plant nutrients can be retained. This helps maintain the nutrients in the region of plant roots when applied to soil and reduces leaking and evaporation.

Thus the fertiliser compositions of the invention provide improved availability of nutrients to the roots of a plant. Using the present invention nutrients can be delivered in an efficient and beneficial way.

The invention will now be further described with reference to the following non-limiting examples.

### Example 1

A sample of 640 ml of water containing 360 g (4.56 mol) of NH₄HCO₃ was taken from a stock solution of ammonium bicarbonate formed by the bubbling carbon dioxide through ammonia solution. The temperature of the solution was 13° C. and the pH of solution was ca. 8 (tested with pH paper). 392.6 g (2.28 mol) of CaSO₄▪2H₂O was slowly added into the NH₄HCO₃ aqueous solution portion by portion over 1 hour and 25 min with vigorous stirring.

With addition of CaSO₄▪2H₂O into the solution, a lot of bubbles was produced which is CO₂ gas. The pH and temperature were monitored time by time through the reaction process. After CaSO₄▪2H₂O addition was complete, the temperature had increased to 15.8° C. and the pH had dropped to 6-7 (tested with pH paper). The reaction mixture was stirred overnight (24 h) until no bubbles were observed. The solid collected by filtration and dried in air for a week to obtain 258.6 of white caked solid.

One part of the resultant mixture was admixed with two parts of an anaerobic digestate solid cake comprising partially decomposed organic matter including cellulosic fibres.

The material was then pelletized using a Farm feeds mini press into 5 mm diameter pellets.

These pellets were then incorporated at a rate of 5 wt% and 10 wt% into the growing media used for the production of lupins.

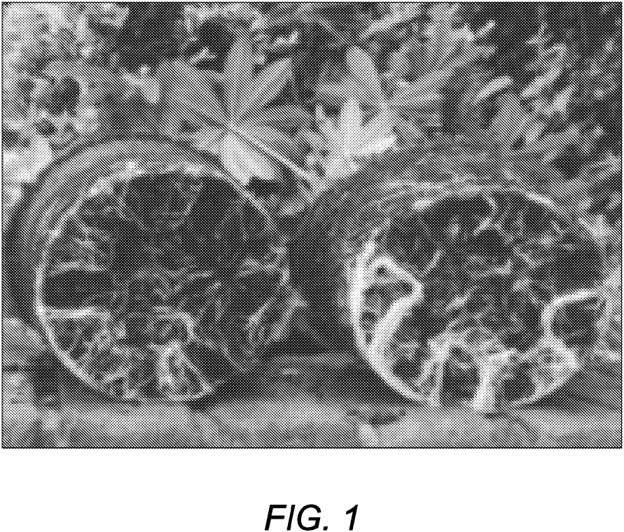

FIG. 1 shows the roots of two plants. The plant on the left was grown in a medium comprising 5 wt% of the fertiliser pellets. The plant on the right was grown in a medium comprising 10 wt% of the fertiliser pellets. It can be clearly seen that the plants, especially the roots, have produced a positive growth response to the increasing presence of the fertiliser pellets.

### Example 2

The fertiliser of the present invention prepared according to example 1 was compared with a standard commercially available ammonium nitrate fertiliser.

Equivalent amounts of the inventive fertiliser and the comparative material were spread over adjacent plots on which oil seed rape were grown.

The crop yield per hectare was measured for various concentrations of fertiliser.

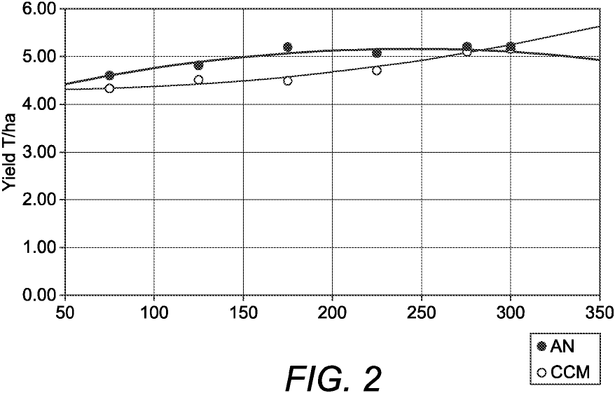

The results are shown in FIG. 2. The x-axis indicates the amounts of fertiliser applied in units of kgN/Ha.

1. A method of producing a fertiliser composition, the method comprising:
(a) providing a composition comprising ammonia;
(b) contacting the composition provided in step (a) with: (i) a composition comprising carbon dioxide; (ii) a source of sulfate ion; and (iii) cellulosic fibres.

2. The method according to claim 1 wherein the composition provided in step (a) comprises an anaerobic digestate.

3. The method according to claim 2 wherein the composition provided in step (a) comprises an anaerobic digestate and from 30 to 40 wt% ammonia.

4. The method according to claim 1 wherein the composition comprising carbon dioxide used in step (b)(i) is a gaseous composition.

5. The method according to claim 4 wherein the composition comprising carbon dioxide comprises the exhaust gases from the combustion of a fossil fuel.

6. The method according to claim 4 wherein the composition comprising carbon dioxide comprises biogas.

7. The method according to claim 1 wherein step (b)(iii) involves adding a compost material comprising cellulosic fibres to the mixture obtained in step (a).

8. The method according to claim 1 wherein the source of sulfate ion comprises gypsum.

9. The method according to claim 1 which further involves adding a source of nitrate ions.

10. The method according to claim 1 which further involves adding a source of phosphorus.

11. The method according to claim 1 wherein step (b)(iii) is carried out before step (b)(i) and step (b)(ii).

12. A method according to claim 1 wherein step (b)(iii) is carried out after step (b)(i) and step(b)(ii).

13. A method according to claim 1 which further involves a step (c) of pelletising the material obtained after steps (b).

14. A fertiliser composition obtained by the method of claim 1.

15. A method of increasing the nutrient content of a plant growing medium, the method comprising:
(a) providing a composition comprising an ammonia;
(b) contacting the composition provided in step (a) with: (i) a composition comprising carbon dioxide; (ii) a source of sulfate ions; and (iii) cellulosic fibres;
(c) optionally pelletising the material obtained after steps (b); and
(d) admixing the mixture obtained after steps (b) and/or (c) with the plant growing medium.
